(19) United States
(12) Patent Application Publication
(10) Pub. No.: US 2004/0110471 A1
(43) Pub. Date: Jun. 10, 2004

(54) Infrared communication module with function of transmitting remote control signal, and portable device and mobile telephone provided therewith

(75) Inventor: Hironori Taniguchi, Kitakatsuragi-gun (JP)

Correspondence Address: MORRISON & FOERSTER LLP, 755 PAGE MILL RD, PALO ALTO, CA, 94304-1018, US

(73) Assignee: SHARP KABUSHIKI KAISHA, Osaka-shi (JP)

(21) Appl. No.: 10/728,238

(22) Filed: Dec. 3, 2003

(30) Foreign Application Priority Data
Dec. 4, 2002 (JP) 2002-352782

(51) Int. Cl. H04B 10/00; H04B 11/00

(52) U.S. Cl. 455/41.1; 379/56.1; 455/575.1

(57) ABSTRACT

In an infrared communication module with a function of transmitting a remote control signal including a light-emitting element for a remote control signal and a light-emitting element for infrared communication, the light-emitting element for infrared communication and the light-emitting element for the remote control signal are arranged in a region corresponding to a single lens. In this way, the module can be downsized while having the light-emitting element producing a signal for infrared communication and the light-emitting element producing a remote control signal.

### BACKGROUND OF THE INVENTION

1. Field of the Invention

The present invention relates to an infrared communication module with a function of transmitting a remote control signal, and to a portable device and a mobile telephone with such infrared communication module.

2. Description of the Background Art

Infrared communication is widely used for communication between portable devices such as a mobile telephone or a Personal Data Assistant (PDA) or for communication between a portable device and a personal computer or the like.

Conventionally, a portable device such as a mobile telephone with both the infrared communication function and a function of transmitting a remote control signal has been proposed. In the conventional device, an infrared communication module for performing infrared communication and a remote control signal transmission module for transmitting a remote control signal have separately been provided. Since these two separate modules are mounted on the device, the packaging area can consequentially be large. As a result, downsizing of the device has not easily been achieved.

In order to accomplish downsizing, an element emitting a signal for infrared communication and an element emitting a remote control signal are combined into one so that these two signals are emitted from a single light-emitting element, as described in Japanese Patent Laying-Open No. 2000-138640.

In addition, when a portable device such as a mobile telephone is intended to have both the infrared communication function and the function of transmitting the remote control signal, a module that emits these signals is attached to the end of the portable device such that the direction of the central axis of a lens of the module coincides with the longitudinal direction extending along the display surface of a display portion of the portable device. In the conventional module, the direction of the central axis of the lens coincides with directions of infrared communication light and remote control signal transmission light emitted from the module via the lens. That is, in the conventional portable device, its longitudinal direction coincides with the directions of the infrared communication light and the remote control signal transmission light.

The infrared communication light and the remote control signal transmission light have considerably different specifications from each other, particularly in wavelength and communication distance. This may result in a light-receiving element failing to receive emitted remote control signal transmission light or infrared communication light. In order to prevent such failure, the amount of light emission may be increased. In this case, however, the power consumption will increase and thus the battery life will be adversely affected. Due to these problems, the emission of both the infrared communication light and the remote control signal transmission light from the single light-emitting element as in the module described in the above-cited document is difficult to achieve.

The conventional module has been formed such that the direction of the light-emitting element producing the infrared communication light coincides with the direction of the light-emitting element producing the remote control signal transmission light. Such module has been attached to a device such that the directions of the lights coincide with the longitudinal direction extending along the display surface of the display portion of the device. In this case, however, problems as set forth below arise.

A portable device can be a greater convenience if a user can use it while watching and checking an indication on the screen of the display portion formed of a liquid crystal display device or the like. In a conventional mobile telephone 51 shown in FIG. 18, its module is attached thereto as described above. Therefore, if infrared communication light is emitted from the mobile telephone while its user is watching a display portion 52 as shown in FIG. 18, the direction of the infrared communication light would not coincide with the direction of a counterpart mobile telephone 51. As a result, communication fails. By comparison, if the infrared communication light is directed to the other mobile telephone as shown in FIG. 19, the display surface of display portion 52 will be held substantially horizontally, and the user cannot see display portion 52 clearly.

When mobile telephone 51 is a foldable type as shown in FIG. 19, it typically includes a first body 53 having a control portion and a second body 54 having a display portion, and first body 53 is held inclined with respect to second body 54. In this type of mobile telephone 51, if the infrared communication light emitted from an end of second body 54 is directed to the other mobile telephone (or horizontally), first body 53 having the control portion inclines downward. This forces the user to operate the control portion in an unnatural and uncomfortable manner, resulting in poor operability.

Similarly, when mobile telephone 51 is utilized as a remote control unit, due to narrow directivity of the remote control signal transmission light, the end of the mobile telephone needs to be directed to respective devices to be operated. In this case as well, there is a problem similar to that described above with respect to the infrared communication.

### SUMMARY OF THE INVENTION

It is an object of the present invention to provide an infrared communication module with a function of transmitting a remote control signal that can be downsized while having a light-emitting element producing infrared communication light and a light-emitting element producing remote control signal transmission light, and a portable device and a mobile telephone with such a module.

The present invention provides an infrared communication module with a function of transmitting a remote control signal including a light-emitting element for infrared communication and a light-emitting element for a remote control signal. The light-emitting element for infrared communication and the light-emitting element for the remote control signal are arranged in a region corresponding to a single lens.

In the above-described module, the two different light-emitting elements are arranged in a region corresponding to the single lens, thereby sharing the single lens. Therefore, a space for the lens is reduced, whereby the module can be downsized. Additionally, since the light-emitting elements are individually configured, the light-emitting elements optimal for the infrared communication light and the remote control signal transmission light can be selected. Accordingly, the performance will not be degraded.

In the -module, a central axis of remote control signal transmission light emitted from the light-emitting element for the remote control signal via the lens and a central axis of infrared communication light emitted from the light-emitting element for infrared communication via the lens are preferably different in direction. In this configuration, the directions of the remote control signal transmission light and the infrared communication light can be adjusted depending on the application so that the module can be utilized more conveniently.

In the module, the light-emitting element for the remote control signal can preferably be provided on the central axis of the lens, while the light-emitting element for infrared communication can be provided offset from the central axis of the lens. Alternatively, the light-emitting element for infrared communication can be provided on the central axis of the lens, while the light-emitting element for the remote control signal can be provided offset from the central axis of the lens. In this configuration, of two signals, one can be set to coincide with the direction of the central axis of the lens, while the other can be set at a different direction.

In the module, more than one light-emitting element for the remote control signal can be arranged in a region corresponding to the single lens. Moreover, the light-emitting elements for the remote control signal can be provided symmetrically with respect to the central axis of the lens. The light-emitting element for infrared communication can be formed of a light-emitting element for IrDA data communication.

The module is preferably attached to a portable device. Since the downsized module is provided in this case, the portable device can also be reduced in size.

The module can be attached to a mobile telephone with a display portion. At least one of a central axis of remote control signal transmission light emitted from the light-emitting element for the remote control signal via the lens and a central axis of infrared communication light emitted from the light-emitting element for infrared communication via the lens can form a prescribed inclination angle with the display surface of the display portion. In this case, the inclination angle can be set at an appropriate angle so that the user can easily carry out a remote control operation or infrared communication while watching the display portion.

For example, the inclination angle is preferably an angle allowing one of the central axis of the remote control signal transmission light and the central axis of the infrared communication light forming the inclination angle to be in a substantially front direction with respect to a user and in a substantially horizontal direction when the user holds the mobile telephone in a normal state of using the mobile telephone. The inclination angle can be at least 10° and less than 90°.

The module can be attached to a foldable mobile telephone including a first body having a control portion and a second body having a display portion coupled to the first body such that the second body can be opened and closed relative to the first body, the display portion being inclined to face a user when the second body is in an open position while the user horizontally holds the first body. One of a central axis of remote control signal transmission light emitted from the light-emitting element for the remote control signal via the lens and a central axis of infrared communication light emitted from the light-emitting element for infrared communication via the lens can be directed substantially horizontally when the second body is in the open position while the user horizontally holds the first body. In this case, the user can easily operate the mobile telephone while watching the display portion. In addition, the user can easily identify the direction of signal light.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1A is a longitudinal cross-sectional view taken along a line IA-IA in FIG. 1B, showing the structure of an infrared communication module with a function of transmitting a remote control signal in accordance with a first embodiment of the present invention, and FIGS. 1B and 1C are front and side views of the structure of the same infrared communication module.

FIGS. 2 and 3 are views for illustrating directions of light emitted from a light-emitting element in the infrared communication module with the function of transmitting the remote control signal in accordance with the first embodiment of the present invention.

FIG. 4A is a front view of the structure of an infrared communication module with a function of transmitting a remote control signal in accordance with a second embodiment of the present invention, and FIG. 4B is a longitudinal cross-sectional view taken along a line IVB-IVB in FIG. 4A.

FIG. 5A is a front view of the structure of an infrared communication module with a function of transmitting a remote control signal in accordance with a third embodiment of the present invention, and FIG. 5B is a longitudinal cross-sectional view taken along a line VB-VB in FIG. 5A.

FIG. 6 is a graph showing a state in which remote control signal transmission lights emitted from a pair of light-emitting elements for a remote control signal via a lens intensify each other.

FIG. 7 is a front view of the structure of an infrared communication module with a function of transmitting a remote control signal in accordance with a fourth embodiment of the present invention.

FIG. 8 shows a state in which a portable device having attached thereto the module in accordance with the fourth embodiment of the present invention is utilized.

FIG. 9 is a front view of the structure of an infrared communication module with a function of transmitting a remote control signal in accordance with a fifth embodiment of the present invention.

FIGS. 10A and 10B are front and rear views, respectively, of the structure of a mobile telephone in accordance with a sixth embodiment of the present invention.

FIG. 11A is a side view of the structure of the mobile telephone (some parts not shown) of the sixth embodiment of the present invention when it is normally used, and FIG. 11B is an enlarged longitudinal cross-sectional view of an end of the mobile telephone in accordance with the sixth embodiment of the present invention.

FIG. 12 shows a state in which the mobile telephone in accordance with the sixth embodiment of the present invention is utilized.

FIG. 13 is a side view of the structure of a mobile telephone (some parts not shown) in accordance with a seventh embodiment of the present invention when it is normally used.

FIG. 14 shows a state in which the mobile telephone in accordance with the seventh embodiment of the present invention is utilized.

FIGS. 15A and 15B are front and rear views, respectively, of the structure of a mobile telephone in accordance with an eighth embodiment of the present invention.

FIG. 16 is a side view of the structure of the mobile telephone (some parts not shown) in accordance with the eighth embodiment of the present invention when it is normally used.

FIG. 17 shows a state in which the mobile telephone in accordance with the eighth embodiment of the present invention is utilized.

FIGS. 18 and 19 show a state in which infrared communication is performed between conventional mobile telephones.

### DESCRIPTION OF THE PREFERRED EMBODIMENTS

### First Embodiment

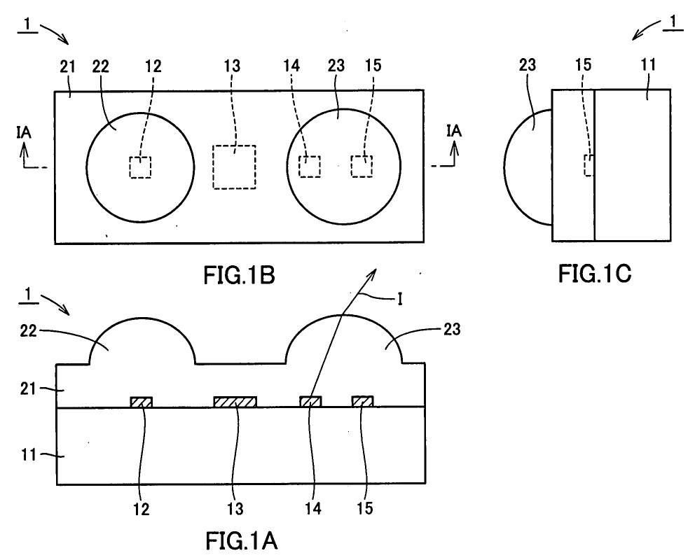

Referring to FIGS. 1A to 3, an infrared communication module with a function of transmitting a remote control signal in accordance with the present embodiment will now be described.

As shown in FIGS. 1A to 1C, an infrared communication module 1 with a function of transmitting a remote control signal in the present embodiment is configured to have a light-receiving element for infrared communication 12 for IrDA data formed of a PD (photodiode) chip, an IC chip 13, a light-emitting element for infrared communication 14 for IrDA data formed of an LED chip, and a light-emitting element for a remote control signal 15 formed of the LED chip on a substrate 11 such as a PWB (Printed Writing Board). Light-receiving element for infrared communication 12, IC chip 13, light-emitting element for infrared communication 14, and light-emitting element for the remote control signal 15 are covered with transparent seal resin 21. IC chip 13 incorporates a control circuit for light-emitting elements 14 and 15 and light-receiving element 12.

Seal resin 21 forms a pair of dome-shaped lenses 22 and 23. Light-receiving element for infrared communication 12 is provided on the central axis of lens 22. Under lens 23, light-emitting element for infrared communication 14 and light-emitting element for the remote control signal 15 are provided offset from the central axis of lens 23.

In the present embodiment, two light-emitting elements 14 and 15 are arranged in a region corresponding to lens 23 so that lights emitted from both elements pass through lens 23, whereby module 1 is made small in comparison with the case in which lenses are provided for light-emitting elements 14 and 15, respectively. This allows a packaging area for module 1 to be made smaller. In addition, since the amount of lens 23 is reduced, cost reduction can be accomplished.

In the present embodiment, light-emitting element for infrared communication 14 and light-emitting element for the remote control signal 15 are at the same height as the central axis of lens 23 in FIG. 1B. Both central axes I and R of infrared communication light and remote control signal transmission light emitted from these light-emitting elements 14 and 15 via lens 23 are set to be converged by lens 23 and pass through the center of lens 23.

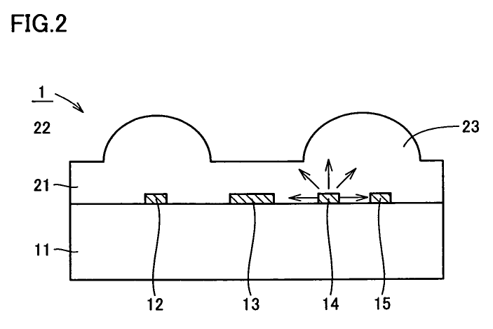

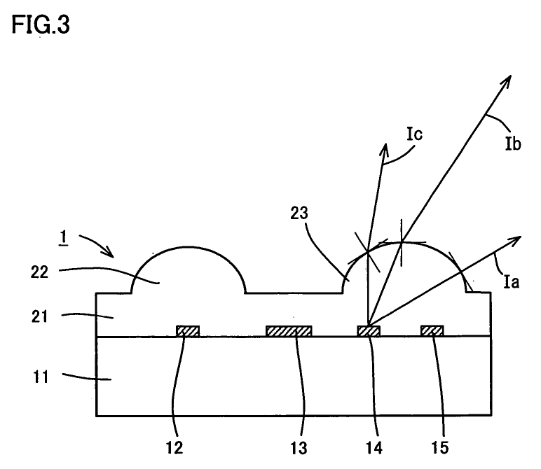

Light-emitting elements 14 and 15 emit light practically in various directions as shown in FIG. 2. That is, the direction of light emission is not limited, for example, to a direction Ib of the center of lens 23 in FIG. 3, but the light can also be emitted to some extent in other directions Ia and Ib for example. The lights emitted from light-emitting elements 14 and 15 are converged by lens 23. Therefore, the central axis of the light emitted through lens 23 is eventually in direction Ib of the center of lens 23.

As shown in FIG. 1A, the light emitted from light-emitting element for infrared communication 14 for example is converged by lens 23. Central axis I of the light passes through the center of lens 23 and is refracted to proceed in the direction indicated by an arrow. In addition, since light-emitting element for infrared communication 14 and light-emitting element for the remote control signal 15 are provided at the same height as the central axis of lens 23, central axes of the lights emitted from light-emitting elements 14 and 15 via lens 23 proceed in different directions at the same horizontal plane including the central axis of lens 23.

Among the lights emitted from light-emitting elements 14 and 15 in various directions, only the one that travels in the direction of the center of lens 23 is representatively shown in the drawings for embodiments described below.

A surface-emitting light-emitting element or the like may be employed as light-emitting elements 14 and 15 so that the direction of the light emitted from the light-emitting element is limited to some extent, and the light is further converged by lens 23. In this way, the direction of the central axis of the light from lens 23 may be fixed to a prescribed direction.

The above-mentioned IrDA (Infrared Data Association) is a representative standard for infrared communication. In the standard, a modulated electric signal is transmitted by an optical signal, and the optical signal is demodulated to an electric signal. In IrDA 1.2 Low Power, which is one of the standards defined by the IrDA, a communication distance of infrared communication light is 20 cm, a maximum transmission speed is 115.2 bps, a directivity is ±15° on both the light-emitting and light-receiving sides, a light-emission intensity is MIN 3.6 mW/sr, and an optical wavelength is 850 nm to 900 nm.

By comparison, remote control signal transmission light for a remote control signal transmitter often used for controlling a television, an air conditioner, a toy, or the like is a signal transmitted in an ASK (Amplitude Shift Keying) having a communication distance of approximately 8 m, a directivity of approximately 15° to 20° at a half angle (the light-emission intensity being 50% of a peak value), and a light-emission intensity of approximately 40 mW/sr. The optical wavelength is approximately 900 nm to 1000 nm.

As described above, the infrared communication light and the remote control signal transmission light are considerably different, particularly in wavelength and communication distance. Therefore, emission of both the infrared communication light and the remote control signal transmission light from a single light-emitting element is not easily performed. By arranging two light-emitting elements 14 and 15 in a region corresponding to the single lens as in the present embodiment, a conventional control circuit or the like can be used as it is and module 1 can easily be downsized.

In the present embodiment, light-emitting element for infrared communication 14 complies with the IrDA standard. Alternatively, an element complying with another standard such as the ASK may also be utilized.

### Second Embodiment

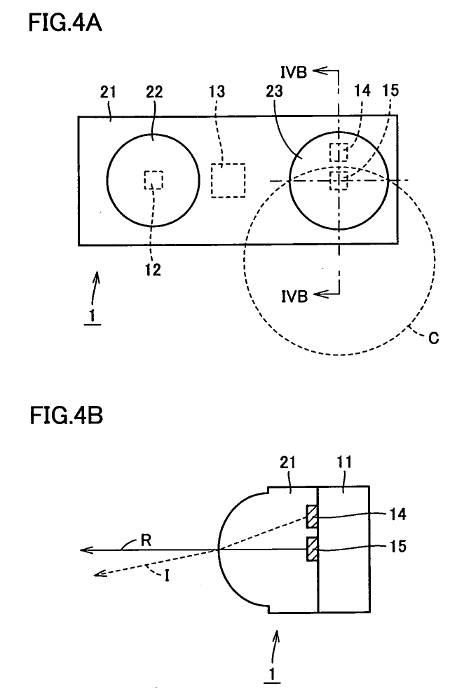

Referring to FIGS. 4A and 4B, only the configuration different from that of the first embodiment will be described in the present embodiment.

In the present embodiment, light-emitting element for a remote control signal 15 is provided on the central axis of lens 23. Light-emitting element for infrared communication 14 is provided, in FIG. 4A, above light-emitting element for the remote control signal 15. Such configuration is made in order that central axes I and R of the infrared communication light and the remote control signal transmission light emitted from light-emitting elements 14 and 15 respectively proceed in directions shown in FIG. 4B.

Central axis R of the remote control signal transmission light travels in a straight line on the central axis of lens 23, and proceeds in the horizontal direction in FIG. 4B. By contrast, light-emitting element for infrared communication 14 is arranged at a position offset from the center of lens 23 in an upward direction. As a result, central axis I of the infrared communication light emitted from light-emitting element for infrared communication 14 passes through the center of lens 23 and is refracted so that it proceeds in a direction slightly downward with respect to the horizontal direction in FIG. 4B. A directivity of the infrared communication light at this time is shown by a circle C in FIG. 4A. While radially spreading as shown in FIG. 4A, the infrared communication light travels in the direction shown in FIG. 4B. A manner in which module 1 of the present embodiment is utilized will be described hereinafter.

The present embodiment may be modified. The positions of light-emitting element for the remote control signal 15 and light-emitting element for infrared communication 14 may be replaced with each other. That is, light-emitting element for infrared communication 14 may be provided on the central axis of lens 23, while light-emitting element for the remote control signal 15 may be provided above light-emitting element for infrared communication 14. A manner in which the modification of the second embodiment is used will also be described hereinafter.

### Third Embodiment

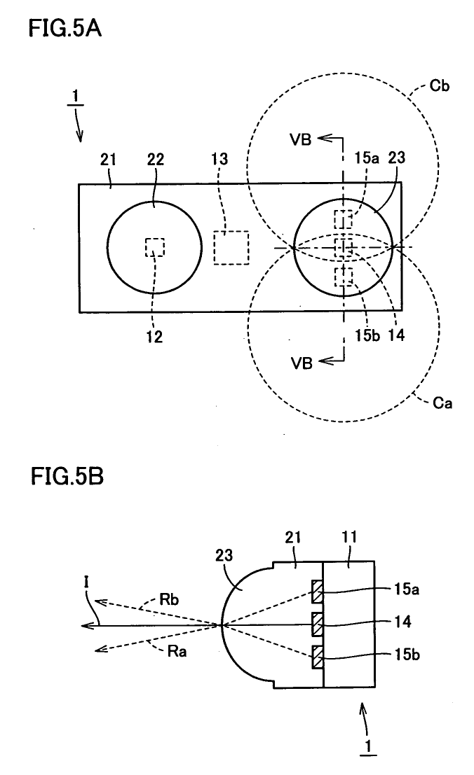

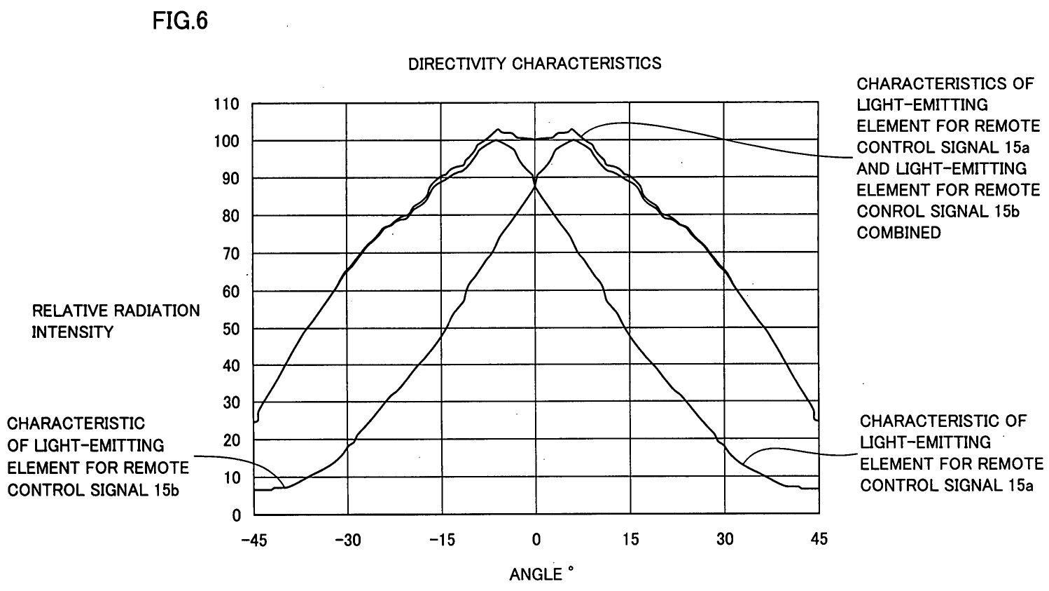

Referring to FIGS. 5A to 6, only the configuration different from those of the above-described embodiments will be described in the present embodiment.

As shown in FIG. 5A, in the present embodiment, light-emitting element for infrared communication 14 is provided at the center of lens 23. At upper and lower positions with respect to light-emitting element 14, a pair of light-emitting elements for a remote control signal 15a and 15b are provided symmetrically with respect to the central axis of lens 23. The purpose of providing the elements in this way is to achieve a wide directivity for the remote control signal transmission light and to obtain remote control signal transmission light with a relatively high radiation intensity even in the direction of the central axis of lens 23.

Central axis I of the infrared communication light emitted from light-emitting element for infrared communication 14 travels in a straight line on the central axis of lens 23. Central axes Ra and Rb of the remote control signal transmission lights emitted from light-emitting elements for the remote control signal 15a and 15b via lens 23 pass through the center of lens 23 to be refracted to proceed in downward and upward directions with respect to the central axis of lens 23, respectively. Directivities of the remote control signal transmission lights are shown by circles Ca and Cb in FIG. 5A.

Provision of the pair of light-emitting elements for the remote control signal 15a and 15b at the upper and lower positions as described above and simultaneous light-emission from these light-emitting elements for the remote control signal 15a and 15b allow the directivity to widen in the upward and downward directions, resulting in the remote control signal transmission light being emitted widely in the upward and downward directions. In addition, directivities Ca and Cb overlap each other in the vicinity of the central axis of lens 23. In the overlapping region, they influence each other to be reinforced. As a result, in the direction of the central axis of lens 23 as well, remote control signal transmission light with a relatively high radiation intensity can be produced.

FIG. 6 shows an example in which the remote control signal transmission lights emitted from the pair of light-emitting elements for the remote control signal 15a and 15b intensify each other. As shown in FIG. 6, the lights reinforce each other at approximately 0° at which the directivities overlap. Accordingly, a higher radiation intensity can be achieved than in the case where a single light-emitting element is utilized.

By providing the pair of light-emitting elements for the remote control signal 15a and 15b at the upper and lower positions symmetrically with respect to the central axis of lens 23 as described above, the high radiation intensity can be achieved even in the axial direction of lens 23, and the directivity can be widened in the upward and downward directions.

The directivity that is wide in both upward and downward directions is suitable for an operation of a device such as an air conditioner dose to a ceiling or of a television or a toy on a floor for example.

### Fourth Embodiment

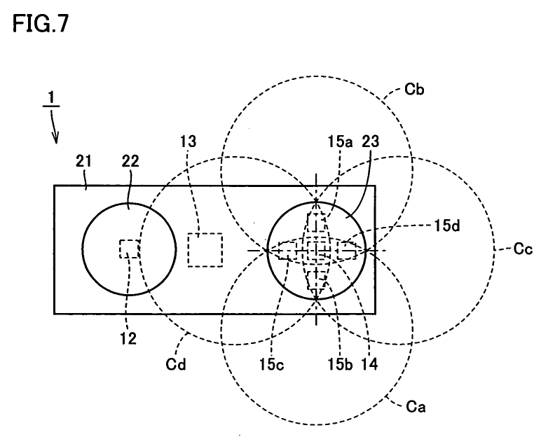

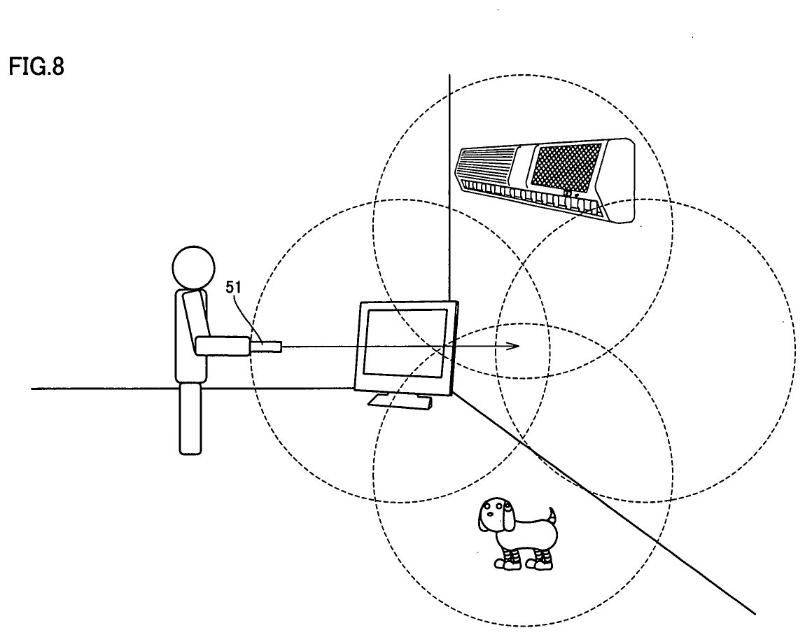

Referring to FIGS. 7 and 8, only the configuration different from that of the third embodiment will be described in the present embodiment.

A module in the present embodiment is different from infrared communication module 1 with the function of transmitting the remote control signal in the third embodiment in that additional light-emitting elements for a remote control signal 15c and 15d are symmetrically arranged at left and right positions with respect to the central axis of lens 23. Directivities of the remote control signal transmission lights emitted therefrom are shown by circles Cc and Cd in FIG. 7. When four light-emitting elements for the remote control signal 15a, 15b, 15c, and 15d are provided as described above, their directivities Ca, Cb, Cc, and Cd overlap each other in the vicinity of the central axis of lens 23, whereby the radiation intensity further increases in the vicinity of the central axis, and even better performance can be achieved in the direction of the central axis of lens 23. In addition, the directivity widens not only in the upward and downward directions, but also in the left and right directions. Provision of such module 1 to portable device 51 allows a remote control operation in a wide range. That is, even when portable device 51 is held in the horizontal direction as shown in FIG. 8, an air conditioner dose to a ceiling, or a television or a toy on a floor can be controlled. Accordingly, the portable device can be used more conveniently.

### Fifth Embodiment

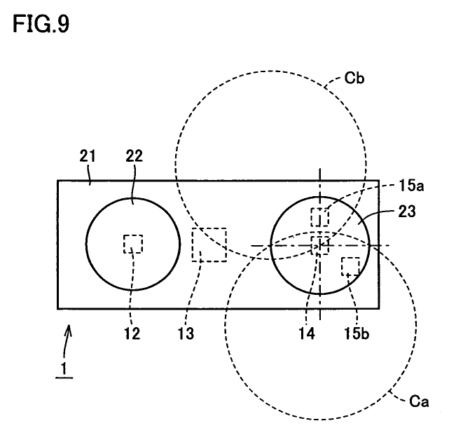

Referring to FIG. 9, only the configuration different from that of the third embodiment will be described in the present embodiment.

As shown in FIG. 9, in the present embodiment, light-emitting element for a remote control signal 15a is provided at the upper position with respect to light-emitting element for infrared communication 14, and light-emitting element for a remote control signal 15b is provided at a lower-right position with respect to light-emitting element 14. In this case, directivities Ca and Cb widen in the downward and the upper-left directions. When a direction of a device to be remotely controlled is limited, such arrangement is also useful.

In the third to fifth embodiments as described above, light-emitting element for infrared communication 14 is provided on the central axis of lens 23, and a plurality of light-emitting elements for a remote control signal 15 are provided around light-emitting element 14 so that the directivity is widened. Alternatively, the positions of elements 14 and 15 may be switched. That is, light-emitting element for the remote control signal 15 may be provided on the central axis of lens 23, and light-emitting elements for infrared communication 14 may be provided around light-emitting element 15. The direction of the infrared communication light, however, should desirably be limited for security reasons. Therefore, the alternative way as described above is not generally suitable. It may, however, be useful in a special case where such a condition is exceptionally required.

As described in the first to fifth embodiments, the directions of the remote control signal transmission light and the infrared communication light can be set freely by adjusting the positions of the light-emitting elements relative to the lens. The directions can also be set freely by adjusting the diameter of the lens and the distance between the lens and the light-emitting element. As described above, the directions of the remote control signal transmission light and the infrared communication light at which the peak sensitivity is high can be adjusted in accordance with the intended use. This allows the infrared communication module with the function of transmitting the remote control signal to be made optimum for various uses.

In the following, embodiments of a device using the above-described infrared communication module 1 with the function of transmitting the remote control signal will be described.

### Sixth Embodiment

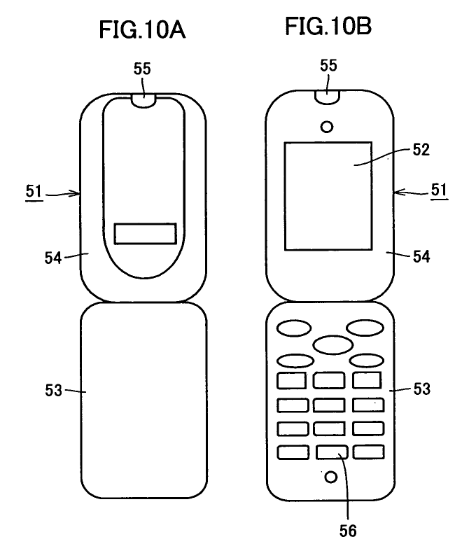

Referring to FIGS. 10A to 12, the present embodiment will be described.

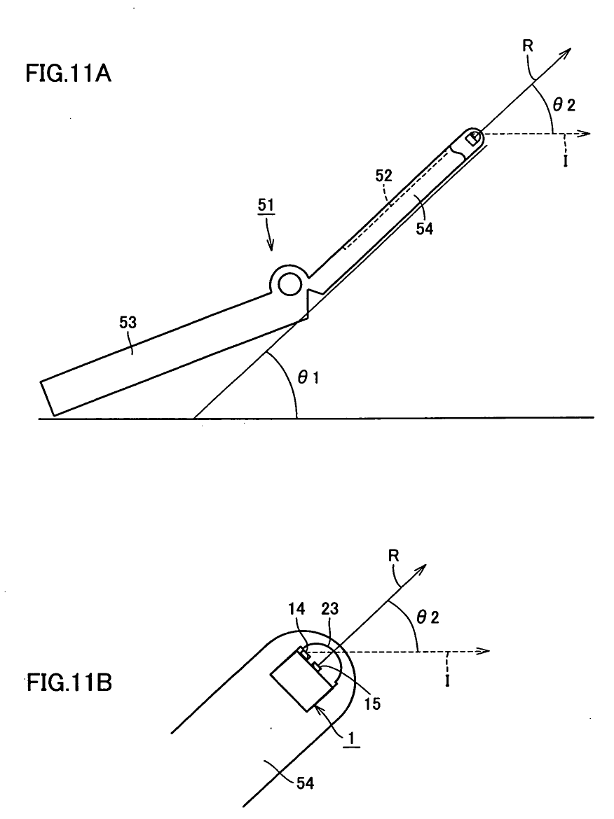

As shown in FIGS. 10A and 10B, mobile telephone 51 of the present embodiment is a foldable mobile telephone. FIGS. 10A and 10B show a state in which it is opened. As shown in FIGS. 10A to 11B, mobile telephone 51 includes first body 53 having control portion 56 and second body 54 having display portion 52 formed of a liquid crystal display device or the like. First body 53 is held inclined with respect to second body 54.

An end 55 of mobile telephone 51 incorporates infrared communication module 1 with the function of transmitting the remote control signal as described in the second embodiment. The central axis of lens 23 of module 1 extends along the longitudinal direction of second body 54 of mobile telephone 51. Central axis R of the remote control signal transmission light is in the direction of the central axis of lens 23. As shown in FIG. 11B, an attachment position of light-emitting element for infrared communication 14 is adjusted. Accordingly, when mobile telephone 51 is held such that an inclination angle θ1 of the display surface of display portion 52 is 45°, central axis I of the infrared communication light is directed horizontally. Therefore, an angle θ2 formed by the direction of central axis R of the remote control signal transmission light and the direction of central axis I of the infrared communication light is also 45°.

When the user utilizes mobile telephone 51 while watching display portion 52, inclination angle θ1 of the display surface of display portion 52 is typically at least 10° and less than 90°. Therefore, θ2 is also preferably set at an angle of at least 10° and less than 90°. More frequently-used inclination angle θ1 is at least 45° and less than 60°. Accordingly, θ2 is preferably set at an angle of at least 45° and less than 60°.

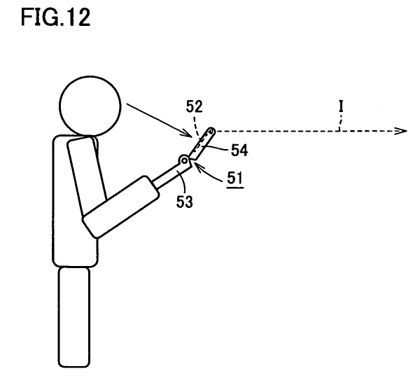

By providing module 1 adjusted as described above to mobile telephone 51 that is a portable device, the user can easily control infrared communication while watching and checking display portion 52 of mobile telephone 51 as shown in FIG. 12, whereby mobile telephone 51 can be used more conveniently. In addition, since module 1 is incorporated within end 55 of mobile telephone 51, transmission and reception therefor can be facilitated.

In the present embodiment, light-receiving element for infrared communication 12 is provided on the central axis of lens 22 as shown in FIGS. 4A and 4B. Light-receiving element 12, however, may be provided at an upper position with respect to the central axis of lens 22 as in the case of light-emitting element for infrared communication 14 so that light-receiving element 12 can easily receive infrared communication light coming from a direction forming angle θ2 with the central axis of lens 22.

Instead of module 1 according to the second embodiment that is utilized in the present embodiment, the module according to the modification of the second embodiment may also be utilized in the present embodiment. In this case, when the user controls the mobile telephone while watching display portion 52, central axis R of the remote control signal transmission light is in the horizontal direction. In such configuration, remote-controlling of a device in the horizontal direction can be facilitated.

### Seventh Embodiment

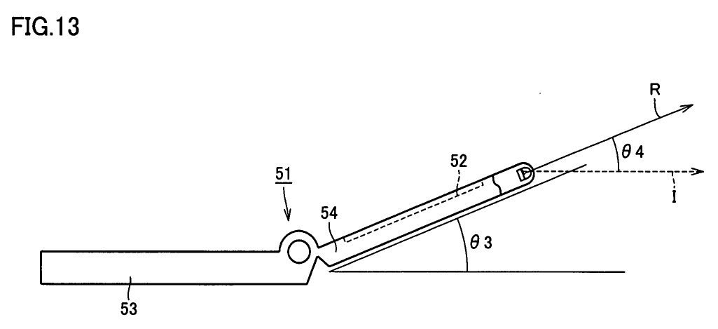

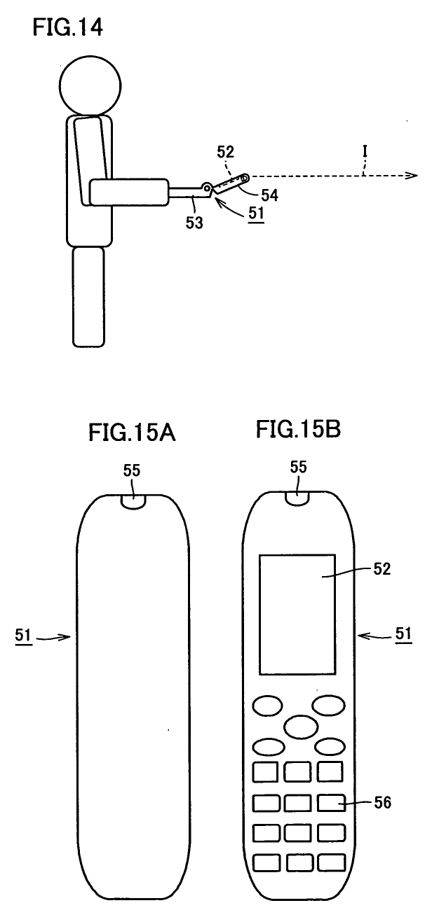

Referring to FIGS. 13 and 14, the present embodiment will be described.

As shown in FIG. 13, mobile telephone 51 of the present embodiment is a foldable mobile telephone. FIG. 13 shows its open state. As shown in FIG. 13, first body 53 is held in a state in which second body 54 is inclined with respect to first body 53 by an inclination angle θ3.

In the present embodiment, module 1 is attached to the mobile telephone such that central axis I of the infrared communication light is directed horizontally when first body 53 is held in the horizontal direction. Therefore, an angle θ4 formed by central axis R of the remote control signal transmission light extending along the longitudinal direction of second body 54 and central axis I of the infrared communication light has the same angle as inclination angle θ3. Angles θ3 and θ4 are each approximately 25° in the present embodiment. They are, however, each at least 10° and less than 30° in a typical mobile telephone.

In this case, the user can emit the infrared communication light in the horizontal direction when the first body with the control portion is held horizontally as shown in FIG. 14. Therefore, the user can easily operate the control portion while carrying out the infrared communication. In addition, the infrared communication light travels in a direction identical with that of first body 53. Therefore, by simply orienting the longitudinal direction of first body 53 to the other device, communication can be performed with highest sensitivity. As described above, since the directions of first body 53 and central axis I of the infrared communication light are the same in the present embodiment, the user can easily identify the direction of central axis I of the infrared communication light at the time of infrared communication.

### Eighth Embodiment

Referring to FIGS. 15A to 17, only the configuration different from that of the sixth embodiment will be described in the present embodiment.

As shown in FIGS. 15A and 15B, in the present embodiment, the module described in the third embodiment is attached to end 55 of non-foldable mobile telephone 51 having a rectangular body with its shorter side down.

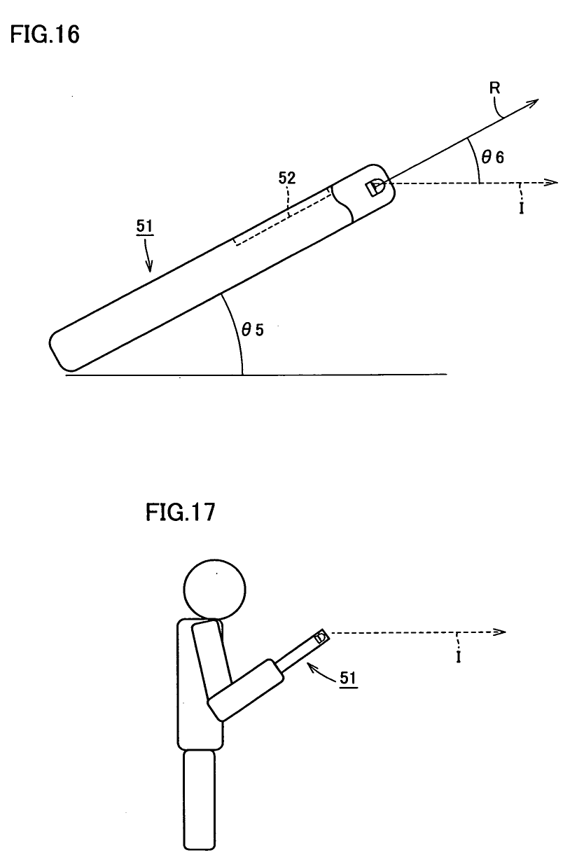

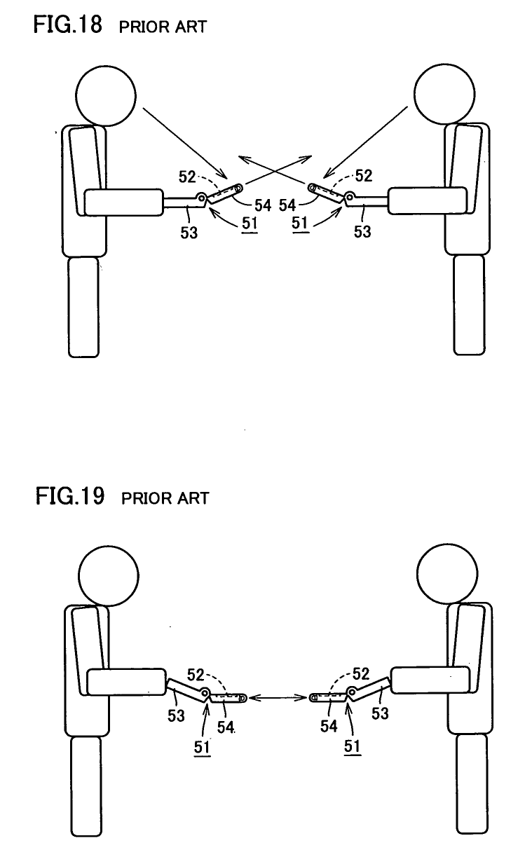

Module 1 utilized in the present embodiment is adjusted such that, as shown in FIG. 16, central axis I of the infrared communication light is horizontally emitted when mobile telephone 51 is inclined at an angle θ5 that is a typical inclination angle in normal use of mobile telephone 51. In this case as well, the infrared communication can be performed in normal use of the mobile telephone as shown in FIG. 17, and the mobile telephone can be enhanced in operability.

In the sixth to eighth embodiments, a mobile telephone has been employed as an example of the portable device. The example of the portable device, however, may be another device such as a PDA.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An infrared communication module with a function of transmitting a remote control signal, comprising:
a light-emitting element for infrared communication; and
a light-emitting element for a remote control signal, wherein
said light-emitting element for infrared communication and said light-emitting element for the remote control signal are arranged in a region corresponding to a single lens.

2. The infrared communication module with the function of transmitting the remote control signal according to claim 1, wherein a central axis of remote control signal transmission light emitted from said light-emitting element for the remote control signal via said lens and a central axis of infrared communication light emitted from said light-emitting element for infrared communication via said lens are different in direction.

3. The infrared communication module with the function of transmitting the remote control signal according to claim 1, wherein said light-emitting element for the remote control signal is provided on a central axis of said lens and said light-emitting element for infrared communication is provided offset from the central axis of said lens.

4. The infrared communication module with the function of transmitting the remote control signal according to claim 1, wherein said light-emitting element for infrared communication is provided on a central axis of said lens and said light-emitting element for the remote control signal is provided offset from the central axis of said lens.

5. The infrared communication module with the function of transmitting the remote control signal according to claim 4, wherein more than one said light-emitting element for the remote control signal are arranged in a region corresponding to the single lens.

6. The infrared communication module with the function of transmitting the remote control signal according to claim 5, wherein said light-emitting elements for the remote control signal are provided symmetrically with respect to the central axis of said lens.

7. The infrared communication module with the function of transmitting the remote control signal according to claim 1, wherein said light-emitting element for infrared communication is a light-emitting element for IrDA data communication.

8. A portable device comprising the infrared communication module with the function of transmitting the remote control signal according to claim 1.

9. A mobile telephone with a display portion, comprising the infrared communication module with the function of transmitting the remote control signal according to claim 1, wherein at least any one of a central axis of remote control signal transmission light emitted from said light-emitting element for the remote control signal via said lens and a central axis of infrared communication light emitted from said light-emitting element for infrared communication via said lens forms a prescribed inclination angle with a display surface of said display portion.

10. The mobile telephone according to claim 9, wherein said inclination angle is an angle allowing one of the central axis of the remote control signal transmission light and the central axis of the infrared communication light forming said inclination angle to be in a substantially front direction with respect to a user and in a substantially horizontal direction when the user holds the mobile telephone in a normal state of using the mobile telephone.

11. The mobile telephone according to claim 10, wherein said inclination angle is at least 10° and less than 90°.

12. A foldable mobile telephone comprising:
a first body having a control portion;
a second body having a display portion coupled to said first body such that the second body can be opened and closed relative to said first body, said display portion being inclined to face a user when said second body is in an open position while the user horizontally holds the first body; and
the infrared communication module with the function of transmitting the remote control signal according to claim 1, wherein
one of a central axis of remote control signal transmission light emitted from said light-emitting element for the remote control signal via said lens and a central axis of infrared communication light emitted from said light-emitting element for infrared communication via said lens is directed substantially horizontally when the second body is in the open position while the user horizontally holds the first body.
